(19) United States
(12) Patent Application Publication
(10) Pub. No.: US 2003/0019764 A1
(43) Pub. Date: Jan. 30, 2003

(54) Under the counter water treatment system

(75) Inventors: Kit G. Baldwin, West Linn, OR (US); Scott A. Schorzman, Kenmore, WA (US); John J. Orolin, West Linn, OR (US); Troy T. C. Johnson, Portland, OR (US); Vaughn A. Sucevich, West Linn, OR (US); Aaron R. Johnson, Hillsboro, OR (US); Greg K. Justice, Portland, OR (US)

Correspondence Address: SEED INTELLECTUAL PROPERTY LAW GROUP PLLC, 701 FIFTH AVE, SUITE 6300, SEATTLE, WA, 98104-7092, US

(73) Assignee: H20 Technologies, Ltd., Milwaukie, OR

(21) Appl. No.: 10/081,862

(22) Filed: Feb. 20, 2002

Related U.S. Application Data
(63) Continuation-in-part of application No. 09/637,955, filed on Aug. 11, 2000, now Pat. No. 6,358,395.

(51) Int. Cl. C25C 7/00; C02F 1/461; C25D 17/00

(52) U.S. Cl. 205/742; 204/252; 204/276

(57) ABSTRACT

An under the counter water treatment system. Water from an outside supply source, such as a municipal water line, is provided to user's home. A prefilter to remove sediment, organic compounds, and certain pollutants is first provided. After the prefilter, the water enters a reverse osmosis system which includes an osmotic membrane. The reverse osmosis membrane filters out impurities and very small particles to provide highly purified water. The outflow of the reverse osmosis filter is stored in a water tank. Water is removed from the tank by releasing an appropriate valve when the user wishes to drink the water. When the water exits the tank, it passes through a mineral supplement which adds minerals to the water beneficial to human or animal consumption. It then passes through an electrolytic cell having a plurality of plates.

### CROSS-REFERENCE TO RELATED APPLICATION

This application is a continuation-in-part of U.S. patent application Ser. No. 09/637,955, filed Aug. 11, 2000, now pending, which application is incorporated herein by reference in its entirety.

### TECHNICAL FIELD

The present invention relates to an electrolytic filter for use in a home, and in particular, to an under the counter system having electrolytic plates for water treatment with a selected filter arrangement.

### BACKGROUND OF THE INVENTION

Electrolytic cells are currently being used in commercial environments to provide oxygenized water for drinking. U.S. Pat. No. 5,911,870 describes a system in which water passes between plates having an electric current between them. The electric current travels through the water, breaking the water molecule into its constituent gasses, hydrogen and oxygen. Much of the oxygen is dissolved in the water after which it is delivered to a tap for drinking water.

### SUMMARY OF THE INVENTION

According to principles of the present invention, an electrolytic converter is provided within an overall water treatment system that is placed under the counter for use in a home environment. Water from an outside supply source, such as municipal water line, well or the like, enters the under the counter treatment system. The water passes through a series of pre-filters which can be designed to remove sediment, residual chlorine large particles, or in some instances volatile organic compounds which may exist in the water supply. After the pre-filters, the water enters a reverse osmosis system which includes an osmosis membrane. The reverse osmosis membrane filters out impurities and very small particles to provide highly purified water. The outflow of the reverse osmosis system is stored in a water tank. The water tank preferably stores the water under pressure so that it can be released upon opening the appropriate valve. When the water exits from the pressure tank, it passes through a carbon filter after which it passes through a mineral supplement system. The mineral supplement system adds beneficial minerals to the water as the water flows through it. These minerals also increase the conductivity of the water which facilitates the use of the electrolytic oxygenation cell which is further downstream. After the water exits the mineral supplement, it passes through an electrolytic cell having a plurality of plates. Current passes between the plates, and thus passes through the water flowing between the plates. This has several affects on the water including, creating oxygen gas which is dissolved in the water, inserting free electrons into the water as well as improving the taste and affinity of the water for excepting other minerals. After passing out of the electrolytic cell, the water passes through a final treatment stage after which it is provided to an outlet tap at a sink for consumption by an end user.

A switch at the tap provides a dual function, first, it opens a valve to release water from the water tank to flow out of the tap. In addition to being a mechanical switch which opens the valve, it also is an electrical switch which sends a signal to an electronic control system. Alternatively, a flow switch may be positioned at any desired location after the pressure tank so that when water is drawn from the tank, a signal is sent based on the water flow. The electronic controls cause the flow of electric current through the plates to begin when water begins to be withdrawn from the tank. Thus, simultaneously with the start of the flow of water, electric current flows through the cell to treat the water. The current flow continues for a selected period of time, even if the water flow stops during this time period. Thus, the water currently in the cell is treated while it is passing through the cell and also, the water which remains in the cell after the flow is terminated is also treated.

If the water flow continues beyond the selected period of time, then the electronic control switches mode such that the switch acts as an electrical on/off switch for power provided to the electrolytic cell. In the second mode of operation, when the switch is closed to stop the flow of water, this also causes the current provided to the cell to terminate. If the switch remains on for an extended period of time, then the electronic controls cause the power to be terminated to the electrolytic cell. A system is therefore provided by which treatment occurs according to a first mode during the start of water flow, switches to a second mode if water flow continues beyond a selected period of time, and switches to a third mode if the activation switch remains enabled for an extended period of time.

### BRIEF DESCRIPTION OF THE DRAWINGS

FIG. 1 is an isometric view of the present invention as used under the counter.

FIG. 2A is a schematic view showing in block diagram form the different elements of the present invention.

FIG. 2B is a side view of one embodiment of the present invention of the under the counter unit.

FIG. 2C is a schematic view showing in block diagram form an alternative embodiment of the present invention having a mineral supplement.

FIG. 2D is a side elevational view of a system installed under the counter according to one embodiment of the present invention.

FIG. 3 is an isometric view of the electrolytic cell according to the present invention, with electronic controls attached thereto.

FIG. 4 is an exploded view of the cell of FIG. 3.

FIG. 5 is a partial cross-sectional view of the electrolytic cell and electronic controls of FIG. 3.

FIG. 6 is a side elevational view of one pressure valve system according to principles of the present invention.

### DETAILED DESCRIPTION OF THE INVENTION

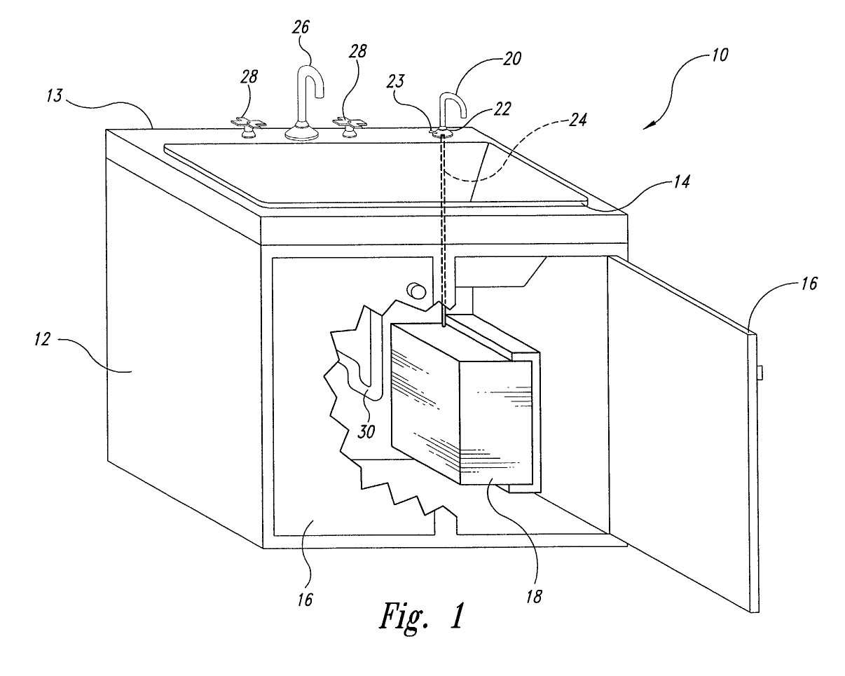

FIG. 1 shows a counter unit 10 which includes the filter system of the present invention. The system 10 includes a cabinet housing 12 having a counter 13 on the top thereof and a sink 14 in the counter. Doors 16 provide access to the interior of the cabinet 12. A water treatment system 18 is connected under the counter 13, below sink 14, so as to provide water to a user from under the counter. At the top of the counter 13 is a clean water tap 20 having a support housing 22 and an actuator switch 23. The tap 20 is of the type style commonly available today which provides specialized delivery of water, such as hot water or filtered water to a sink 14. A pipeline 24 extends from the tap 20 to the water filtration system 18.

Also provided at the sink 14 is the standard faucet 26, with valve controls 28 to provide water from the standard water supply to the sink 14. Piping 30 provides connection from the sink to the drain.

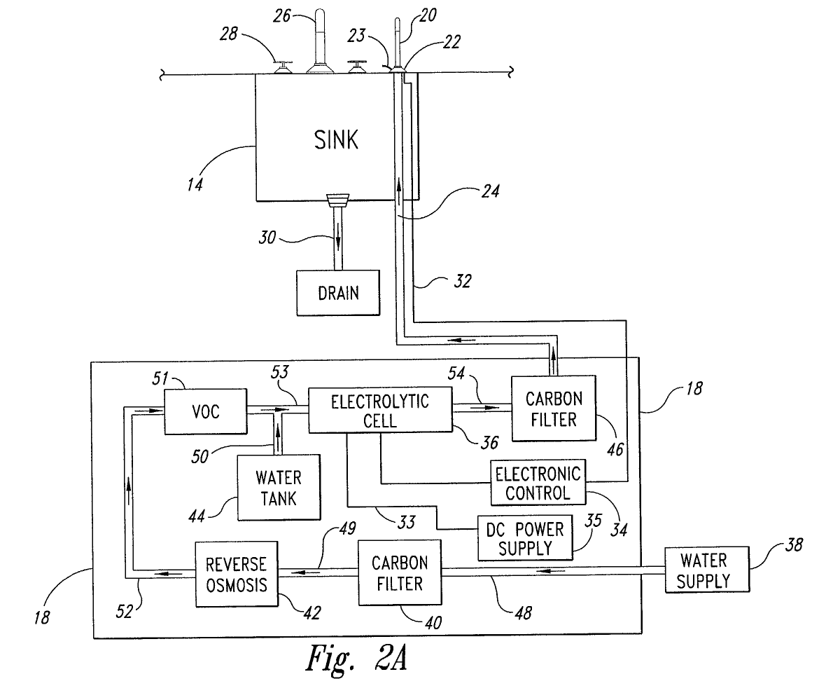

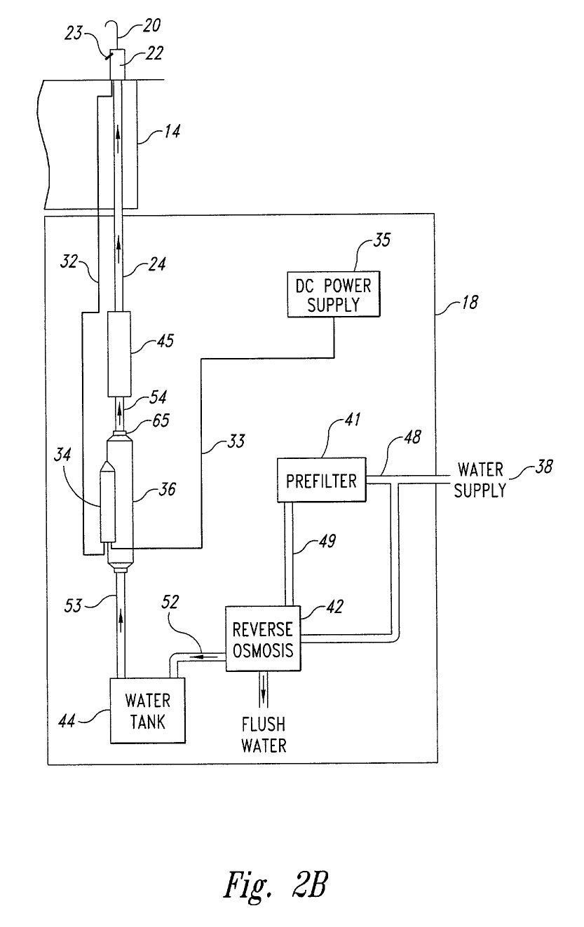

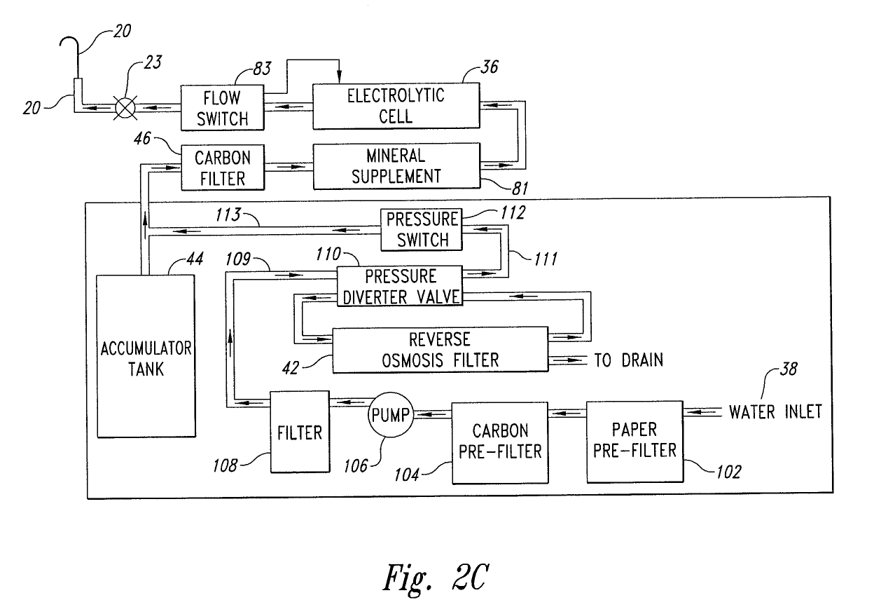

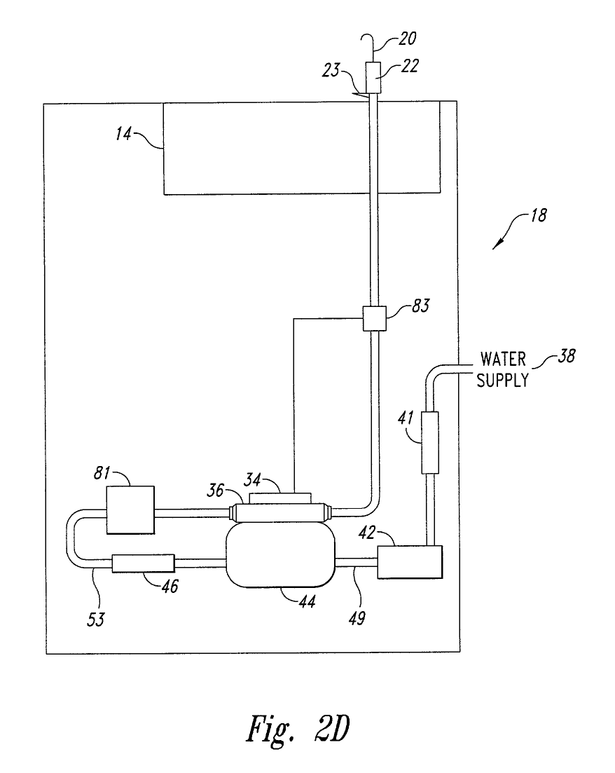

FIG. 2A is a block diagram showing schematically the features of the present invention. The sink 14 includes two water supply taps, a standard faucet 26 controlled by valves 28 and a treated water tap 20 which provides the treated water.

A water supply 38 provides the source of water, under the appropriate pressure to promote flow to the water treatment system 18. The water flows into a pipe 48 to a first filter 40, in this instance a carbon filter. Water exits the carbon filter 40 via outlet pipe 49 and enters a reverse osmosis filter 42. After water exits the reverse osmosis filter 42, it travels through pipe 52 to a VOC filter 51, which refers to a volatile organic compound filter. A VOC filter 51 is the type of filter which removes volatile organic compounds as may be present in the water in the form of gasoline molecules, oils, organic residues from the water supply or other organic compounds which may be present in the water. According to one embodiment, the VOC filter 51 is positioned after the reverse osmosis filter 42. According to a second embodiment, the VOC filter 51 is positioned after the carbon filter 40 but prior to the reverse osmosis filter. The VOC filter 51 therefore removes all the hydrocarbons, organic compounds and other pollutants prior to the water entering the reverse osmosis filter.

Reverse osmosis filters are known generally in the prior art as a single component within an isolated water treatment system. The structure and operation of reverse osmosis filters are well known in the art and therefore need not be described in detail. A brief summary is sufficient as follows. In reverse osmosis filters, an osmotic membrane is provided through which water molecules pass by osmosis. The membrane may be under pressure in some embodiments. The membrane is composed of very small apertures which permits water to pass therethrough. However, it blocks the passing of many molecules larger than water. A majority of bacteria, iron, minerals, heavy metals, and other pollutants in the water are filtered and removed by the reverse osmosis membrane. A reverse osmosis membrane therefore results in highly purified water. Because a reverse osmosis membrane filters a highly purified water, it often does not operate as quickly as a user desires water. Indeed, in some systems the output from a reverse osmosis filter is quite slow, and may be in the form of a series of drips or very slow flow, depending on the type of filter used, its configuration, and the desired output. It is also known that flush water may also be provided to clean the membrane to remove the contaminants from the membrane which have been removed from the water and flush them to a drain so that the reverse osmosis filter may continue clean operation over an extended period of time. As can be appreciated, there are various tradeoffs with respect to cost, throughput speed, and the purification of the water in such a filter system.

The water output from the reverse osmosis filter 42 is provided to a water tank 44 via output line 53. The water tank 44 is provided for those embodiments in which the output flow from the reverse osmosis filter is a low flow rate and it is therefore desired to store a quantity of highly purified water for immediate use. The water tank 44 will normally have a size and a range of 1-3 gallons, and preferable is 1½-2 gallons in size. The water tank 44 stores the highly purified water in clean condition so that it remains purified while awaiting use by the consumer.

An actuator switch 23 is provided near the tap 20 so that the user may withdraw water from the water tank 44. The actuator switch 23 is a two-function switch, first as a valve control to open the valve for water flow, and second as an electrical actuator to provide an electrical signal to the electronic controls 34. This is accomplished by placing an electrical sensor underneath the actuator 23 so that depressing the actuator switch 23 serves to both open the valve and activate the electrical switch.

When water is drawn from the tap 20 by depressing the actuator switch 23, it passes through an electrolytic cell 36. The electrolytic cell 36 has DC power from supply 35 provided thereto by electronic controls 34 so that an electric current passes through the water as it moves through the electrolytic cell 36. The water exits the electrolytic cell 36 via tubing 54 and passes through a second carbon filter 46. After passing through the carbon filter 46, it enters tubing 24 which supplies the highly purified, treated water out tap 20.

FIG. 2A is a block diagram of the schematic concept of the present invention. As can be seen, the water is shown as passing from one filter system to the next until it is eventually provided via tap 20 for the end consumer. While various pipes, angles, and direction changes in water flow in the piping are shown in FIG. 2A, these are schematic only. As will be appreciated, these are schematic in nature and the actual tubing locations and connections will depend on each particular application. For example, according to one embodiment, the carbon filter 46 is positioned directly below the tap 20 so there is no bend in the tubing from the exit of carbon filter 46 to the tap 20, and instead, there is a bend in the tubing 54 between the electrolytic cell 36 and the filter 46 so as to properly position the electrolytic cell 36 within the housing for the treatment system 18. Similarly, there may be a bend in the system between the first filter 40 and the reverse osmosis system 42 and not have any bend in the system between the reverse osmosis filter 42 and the tank 44. Additionally, water from the water supply 38 may pass through a sediment filter prior to the carbon filter 40, allowing for two pretreatment stages. Thus, the exact configuration of the tubing, and the specific location of the various filters with respect to each other may be modified based on the shape of the housing, the available space under the counter, the location of the water supply, and other particular features of each application, all such applications being equivalent to each within the concept of the present invention.

FIG. 2B illustrates one of the possible specific structures according to principles of the present invention. A water supply 38 provides water into the system 18 via a line 48. The water first passes through a prefilter 41 which removes sediment, organic compounds, and other pollutants. In one embodiment, the prefilter 41 is a stage filter of a sediment filter, followed by a volatile organic compound filter (VOC). Alternatively, it may include a carbon filter, a carbon filter in combination with a sediment filter, or other appropriate filters to clean the water prior to entering the reverse osmosis filter 42. The filter water enters the reverse osmosis filter 42 via tubing 49. As water is filtered, it passes through tubing 53 into the water tank 44. As is common with many reverse osmosis filters, two water supplies are provided, first the water which is to be filtered in line 49, and second, a flush water via line 48 which is used to maintain the membrane in a clean operational condition but which is not part of the outlet water. For those reverse osmosis filters 42 which require a flush water, this is provided via piping 48 through the prefilter 41 or via bypass piping around the prefilter 41. The flush water exits via flush water outlet of the reverse osmosis filter 42.

Water passing out of the osmotic membrane enters water tank 42 via pipe 53. The rate at which water passes into the tank 44 via tubing 53 is based on the cleaning rate of the reverse osmosis system 42 and, as previously noted herein, may be a small stream, or even a drip flow rate. The water is accumulated in tank 44 waiting for use.

Upon depressing actuator 23, a valve is opened and water passes out of tank 44 via tubing 53 into the electrolytic cell 36. The electronic controls 34 have a switch connected to the actuator switch 23 which provides a signal to the electronic controls 34. Thus, simultaneously with the valve to tap 20 being opened, an electric current is provided on line 33 from DC power supply 35 to pass between the plates to treat the water in the electrolytic cell 36. After the water passes out the electrolytic cell 36, it is provided via line 24 to outlet tap 20. According to one alternative embodiment, a post filter 45 may be provided after the electrolytic cell 36. This post filter 45 may be mineral deposition filter that places a carefully measured amount of selected minerals into the water. However, in one embodiment, such a post filter 45 is not provided and the water is fed directly from the electrolytic cell 36 to the tap 20.

Tank 44 is constructed of any acceptable design for providing water out of outlet 20 when the valve is opened via actuator switch 23. Normally, the pipe 53 will not be under pressure because of the slow stream of water. Accordingly, another source of pressure is provided to assist water in exiting the tank 44. According to one known technique, an air pressure source is provided to maintain the water in tank 44 under a pressurized system preparing for exit to the tap 20. A membrane is provided to separate the water from the pressurized air. Upon the valve being opened, the pressurized air forces the water out of tank 44 at a selected rate. Alternatively, another source of pressure may be provided, such as a small pump, a connection to pressurized water supply which maintains separation between the highly purified water and the pressure water source, or any other acceptable technique. Since the water in the tank is highly purified water, it is desirable to maintain it separate from all other water or other sources of contamination until it is provided out of tap 20 to the user.

In the embodiment shown in FIG. 2B, the electrolytic cell 36 is positioned vertically in line with the water flow. Therefore, water passing through the electrolytic cell 36 travels upward, in a vertical direction toward the outlet tap. This provides a quiet zone within the tubing 54 during which time more of the oxygen can be dissolved into the water. According to one alternative embodiment, the electrolytic cell 36 is positioned near a bottom portion of the overall water filtration system 18, adjacent the tank 44. The water tank 44 will be of the two to three gallon size and thus be approximately the same height as the electrolytic cell 36 so that it may be easily connected along the sidewall. Water will exit from the water tank 44 and pass into the electrolytic cell 36 and then upward toward the outlet tap 20. In some embodiments, an additional filter 45 is present, while in other embodiments, the filter 45 is not present and the water passes directly from the electrolytic cell 36 to the outlet tap 20.

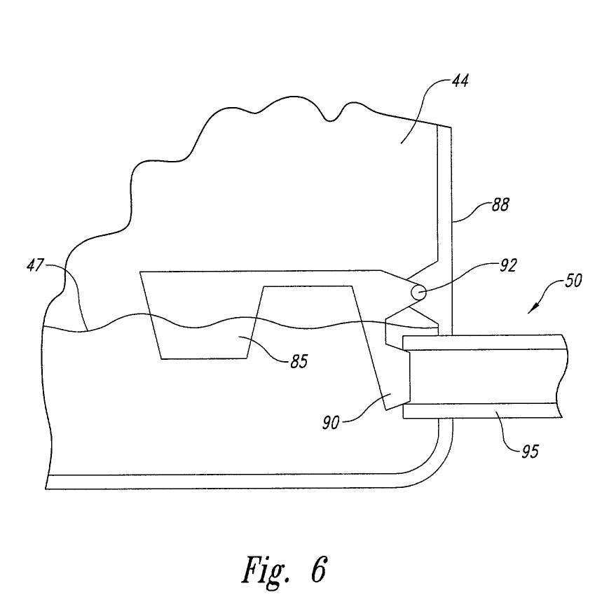

FIG. 2C illustrates a further alternative embodiment, according to principles of the present invention. In this embodiment, the water inlet is coupled to a paper filter 102 through which it first passes. The paper filter 102 provides the advantage of a low cost, easily changeable filtration system for removing a large amount of particles including coarse, and in many instances, relatively file particles. The water then passes through a carbon pre-filter 104. The carbon pre-filter 104 may be an activated carbon filter or a passive carbon filter membrane. It removes a large amount of gases, and very fine particles as well as certain types of bacteria from the water. The water than passes through a pump 106 after which it passes through a further filter 108. This filter 108 may be of any acceptable type to perform a final filtration system such as a volatile organic compound filter (VOC) similar to the VOC 51 as illustrated in FIG. 2A. The pump 106 provides additional pressure to the system in those embodiments where the local water inlet pressure 38 is not as high as desired. The water than passes through a pressure divertive valve 110. The pressure divertive valve 110 outputs the water under pressure into the reverse osmosis filter 42. The cleaned, pure water existing the reverse osmosis filter 42 also enters the pressure diverter valve 110. The pressure diverter valve 110 provides the advantage of maintaining the appropriate pressure for transporting water out of the reverse osmosis filter 42 into the accumulator tank 44. Some of the water pressure arriving at the inlet tubing 109 is diverted to provide pressure at the outlet 111. The water flows are not mixed, so that pure, filtered water is exiting from tube 111 to enter into the accumulator tank 44. However, the pressure diverter valve 110 provides the advantage of using some of the available pressure at the inlet tube 109 for use in providing a steady pressure at the outlet 111. The water then passes into a pressure switch 112 and thereafter into the accumulator tank 44. The pressure switch 112 may be any acceptable switch which prevents back flow of water. It may, for example, be a check valve so that water may flow through in one direction and build up pressure on the downstream side 113 and not affect the pressure in the inlet pipe 111. The pressure switch 112 therefore permits the accumulator tank 44 to build up to considerable pressure and prevents this pressure from affecting the operation of the reverse osmosis filter 42 or the flow of water into and out of the pressure diverter valve 110. In some embodiments, the pressure switch 112 is not present or, in a further alternative embodiment, is within the accumulator tank 44. One acceptable embodiment for having the pressure switch 112 within the tank 44 is show in the embodiment of FIG. 6. As the water leaves the accumulator tank 44, it passes through a carbon filter 46. The carbon filter 46 removes any compounds imparted to the water by the elastomeric diaphragm in the accumulator tank 44, if such elastomeric component is present. Some accumulator tanks contain rubber linings, or may have rubber gaskets or other components which may leave a bad taste in the water. Since the water exiting the reverse osmosis filter is very pure, even a small amount of rubber may create a very bad taste in the water even though it is clean to drink. The carbon filter 46 acts to remove any undesired elements or compounds from the water that may have been imparted by the plastic of the tank 44, the elastomeric parts, the reverse osmosis filter, its membrane, or any other components in the system. In one embodiment, the components that impart the undesirable taste or compounds are not used and therefore the final carbon filter 46 is not present in such embodiment.

Systems which do not use a diaphragm within the accumulator tank 44 may include a number of potential components. For example, a spring-loaded check valve may be used which has a cracking pressure that allows the accumulator tank 44 to retain a precharge of air pressure. Alternatively, a flow valve may be utilized at the exit of the tank that is positioned near the bottom interior of the tank so that the flow from the tank is stopped when the liquid level is low within the tank. It also acts to stop the escape of gas from the tank. According to this embodiment, the tank can retain a precharge of air pressure.

After exiting from the carbon filter 46, if one is present, the water then enters a mineral supplement cell 81. The mineral supplement cell 81 may be any acceptable mineral additive system which imparts the desired minerals, in the proper concentration, into the water. One acceptable mineral supplement is a calcite filter.

As is known, common tap water has a fairly high conductivity and will pass electricity quite readily because of the impurities and other chemicals therein. Reverse osmosis filter 42 outputs very pure water that has a conductivity near zero semens. Extremely pure water has a very low conductivity. Further, extremely pure water, such as the type which has been distilled or completely ionized has a poor taste to people drinking it and does not provide some of the beneficial effects that are desirable from water. According to the present invention, dissolved solids are imparted into the water that are beneficial for human consumption in the mineral supplement 81. The conductivity of the water is also increased significantly by the addition of dissolved solids. This improves the taste, as well as enhances the generation of oxygen because the conductivity is significantly higher providing a greater electrical flow through the water when it passes through the electrolytic cell 36. The minerals selected may be trace amounts of acceptable minerals such as manganese, calcium, zinc, and other minerals which are known in trace amounts to add flavor, as well as some benefit to the health of the humans drinking the water. For example, in one embodiment a small amount of iron may be added while in other embodiments, it may be desired to add trace amounts of sulfur, fluoride or other components rather than, or in addition to, iron.

After the appropriate mineral supplements have been added, the water passes through the electrolytic cell 36. As the water flows through the electrolytic cell 36, an electric current is passed through the water which creates dissolved oxygen in the water. A sensor cell 83 is positioned in the fluid line in one alternative embodiment in order to activate the electrolytic cell 36. When water is drawn from the tap 20, the sensor cell 83 senses the water is flowing to the pipes and provides an electrical signal to activate the electrolytic cell 36 to begin to oxygenize the water. Alternatively, the signal is generated at the valve 13 when the valve is opened to provide water out of tap 20. Thus, the same function which opens the valve also sends an electrical signal to activate the electrolytic cell 36 and the sensor cell 83 is not used. Thus, the flow switch may be replaced by a mechanical switch that is activated by operation of the switch 23.

FIG. 2D is a side elevational view of one actual embodiment according to one alternative embodiment of the present invention. The water supply 38 enters the filtration system 18 and passes through a pre-filter 41. The pre-filter 41 is a single filter in the embodiment show in in FIG. 2D, or may be the three filters, together with the pump and pressure diverter valve, or any combinations thereof as shown in FIG. 2C and FIGS. 2A and 2B. The water then enters the reverse osmosis filter 42 after which it is output to the accumulator tank 44. The size and location of the accumulator tank 44 is selected to be physically close to and adjacent the reverse osmosis filter 42, the piping 49 between them being relatively small in most embodiments. The water is stored in the accumulator tank 44 until it is released by a consumer through tap 20 for use. As water exits the accumulator tank 44, it passes through a filter 46, such as a carbon filter, and then through a mineral supplement system 81. The electrolytic cell 36 is positioned physically on top of, and directly connected to, the accumulator tank 44. In this embodiment, considerable space is saved in producing a functional under-the-counter unit by selecting a size for the electrolytic cell 36 which is approximately equal to, or even slightly smaller than, the dimensions of the tank 44 so that it may conveniently fit directly on top of the tank. A very compact structure can be made, with the proper orientation for all components, by placing the electrolytic cell 36 on top of the accumulator tank 44, similar to the arrangement shown. In an alternative embodiment, the tank 44 is positioned in a vertical orientation so that the electrolytic cell 36 is vertical, similar to that shown in the embodiment of FIG. 2B. However, in one embodiment, the cell is positioned horizontally, on top of the tank, as shown in FIG. 2D.

Water exits from the electrolytic cell 36 and out of the tap 20 under control of a user pressing a switch 23. A flow sensor cell 83 sends an electrical signal to the electronic controls 34 in order to activate the cell upon water passing therethrough. A compact system is therefore provided by which beneficial minerals may be provided to a user while at the same time providing a system that is compact for placing under the counter.

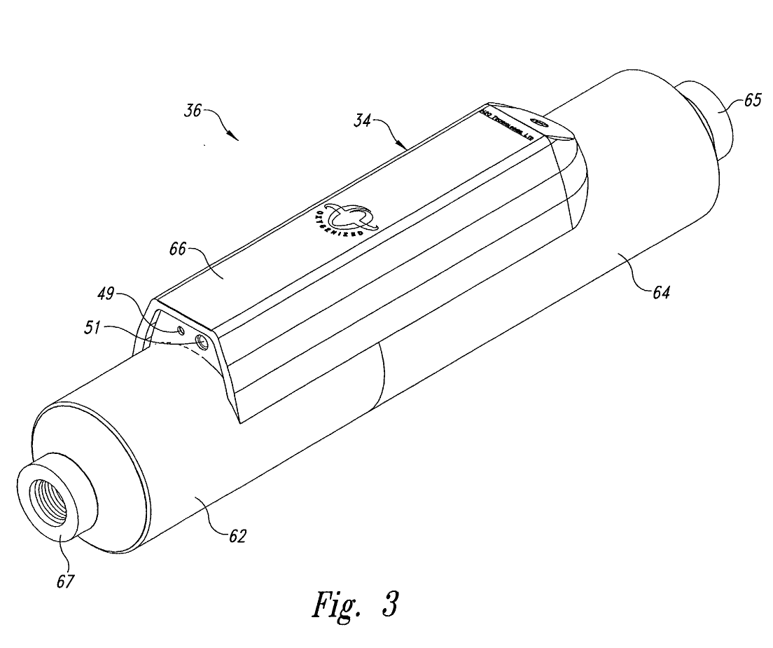

FIG. 3 illustrates the electrolytic cell 36 and the electronic controls 34 attached thereto. The electrolytic cell 36 includes an inlet 67 and an outlet 65. A first housing member 62 is coupled to a second housing member 64. The electronic controls 34 include a housing 66 having apertures 49 and 51 at one end thereof. The wire 32 from actuator switch 23 is provided via opening 49 to activate the power to the electrolytic cell. A DC power supply 35 provides a DC power via wire 33 in the other opening.

The DC power supply 35 may be any acceptable source of direct current power. For example, it may plug into the wall and include an AC to DC converter which converts an AC line current to a DC supply of a known voltage and current capability. Alternatively, it may be a battery, a stand-alone power supply such as a desktop power supply, a DC power line, or any other DC source. The DC power supply 35 may be affixed to the housing of the system 18 or the tank 44.

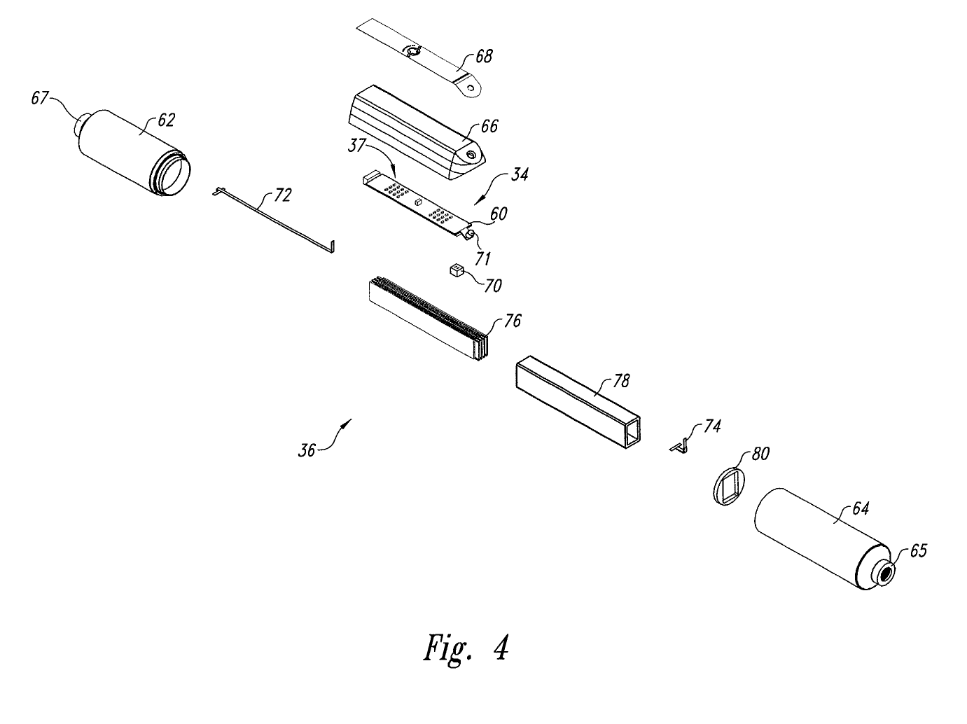

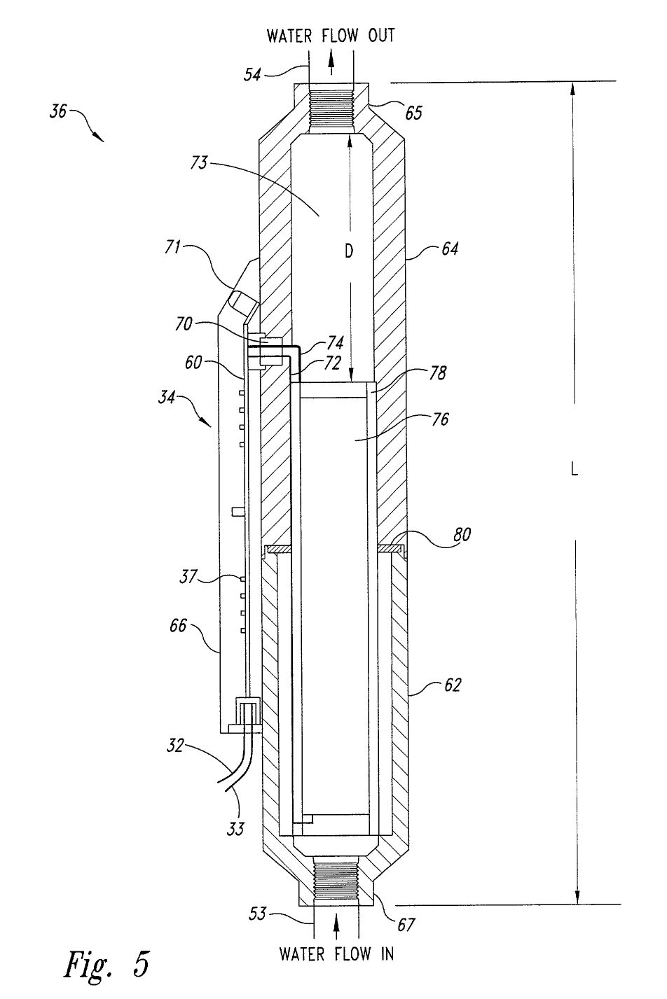

FIG. 4 is an exploded view of the electrolytic cell of FIG. 3, and FIG. 5 is a partial cross-sectional view of the electrolytic cell of FIG. 3. As shown in FIGS. 4 and 5, the electrolytic cell includes plates 76. The plates 76 are made of an electrically conductive material of a type known and acceptable in the art. The plates 76 are held in a precise spaced relationship with respect to each other. When direct current voltage is placed on one or more of the plates, an electric current passes from one plate to an adjacent plate. As the electric current passes from one plate 76 to another plate 76, it passes through water positioned between the plates. A first electrode terminal 74 provides electrical contact from one terminal of the DC power supply to one-half of the plates. Another electrode terminal 72 provides power to the other DC terminal to the other half of the plates. Accordingly, the plates at the first voltage are interleaved with plates held at the second voltage, preferably a positive voltage and ground for the two respective voltages. According to one embodiment, the voltage may, for example, be fifteen volts, twenty-five volts or any acceptable DC value to provide a desired current flow as explained herein. In one embodiment, the voltage is preferably less than 50 volts and more preferably the voltage is 24 volts. The current may be in the range of 1 to 20 amps, and is preferred to be in the range of 1 to 5 amps. A plate housing 78 encloses the plates 76 to retain them in a spaced relationship and mechanically support them within the electrolytic cell 36. A water block 80 is positioned around the housing 78 and abuts against the interior wall of the two housing components 62 and 64 as can be seen in FIG. 5. This block 80 acts as a seal to ensure that all water passes through the electrolytic plates 76 and cannot bypass the housing 78.

The first housing member 62 is affixed to the second housing member 64 by any acceptable technique such as threading, adhesive, soldering, brazing, spin welding or other appropriate watertight seal. Preferably, a threaded connection is used so that the electrolytic cell can be disassembled by unthreading the member 62 from the member 64 and the plate 76 removed for inspection and service.

The electronic controls 34 directly affixed to the housing of the electrolytic cell 36. The electronic controls 34 include a circuit board 60 which includes a number of integrated circuits and components 37 for control of the electronic circuit as described herein. The wire 32 is connected to the circuit board 60 via the appropriate connections to indicate that the actuator switch 23 has been depressed. A DC power supply wire 33 is also coupled to the circuit board 60 and by appropriate switches to electrode 72 and 74 to power the plates 76. An insulation block 70 is provided to mechanically support the board 60 and provide electrical insulation for the electrode 72 and 74. Other appropriate mechanical support and insulation members are also provided to hold circuit board 60 connected to the electrolytic cell 36 and electrically insulated therefrom as could easily be constructed by those of skill in the art. The circuit board may also be coated with a waterproof barrier such as a coating to protect it from soaking. A cover 66 is provided to enclose the circuit board 60 and retain it on the electrolytic cell 36. An appropriate cover plate 68 may also be provided on the housing 66. A signal light 71 which is connected to circuits on circuit board 60 can be seen if illuminated through an opening in the housing 66. The signal light 71 may indicate that the electrolytic cell is currently operating correctly and power is being provided while water is being filtered. Further, the signal light 71 may include two or more lights, of different colors such as red and green, with one color indicating proper operation and the other color indicating that the cell should be checked to confirm that it is operating correctly.

According to a preferred embodiment, the electrolytic cell 36 is vertically oriented when water passes therethrough, as shown in FIGS. 2B and 5. In particular, water flows upwards, against the flow of gravity between plates 76 and exits the pipe 54 as shown in FIG. 2B. The cell has quick disconnect fittings at each end for ease of installation. One example is a push connect fitting. The vertical orientation of the electrolytic cell 36 provides a number of advantages. A dissolving chamber 73 is provided vertically above the plates 76. It has an overall length L of the appropriate size to fit under a counter. A size in the range of 10″-20″ is acceptable with 14″-16″ being preferred. The dissolving chamber 73 has a preset volume and a vertical distance D. In one embodiment, the distance D is in the range of 3-6 inches. The dissolving chamber 73 contains water in a quiet zone undergoing preferably laminar flow. Within this quiet zone, the dissolving chamber provides additional room for the oxygen gas to transition from the gaseous state to a dissolved state within the water. Further, by having the housing vertically oriented, the oxygen has the additional travel through pipe 54 and pipes 24 for the oxygen to transition from the gaseous state to the dissolved state so that a large amount of the generated oxygen is in the form of dissolved oxygen when it exits tap 20. Thus, having the entire system vertically oriented below tap 20 provides further advantages in providing extended length settling zone for the dissolved oxygen beyond that provided by the dissolving chamber 73.

Generally, the hydrogen gas is more difficult to dissolve in the water and a large percent of it will remain in the gaseous state. When water exits tap 20, the hydrogen which remains in the gaseous state will vent to the air and escape upward, whereas the water to be used by the customer, whether for tea, coffee, juice or some other use will have large amounts of dissolved oxygen therein. The use of the electrolytic cell 36 in combination with the reverse osmosis system provides particular advantages not previously obtainable in prior systems. The reverse osmosis system results in highly purified water. Nearly 100% of all non-water molecules are removed from the water including all bacteria, metals, giardia, staphylococcus, and other small pollutants not removed by normal filters. Because the water is highly purified as it exits from the reverse osmosis filter it may often have a flat taste to the consumer. The electrolytic cell 36 adds oxygen to the water, significantly improving the taste and freshness of the water.

In addition, in one embodiment a selective mineral addition filter 45 is provided. It is known that highly purified water may, in some instances be so tasteless as to not be pleasant to the person consuming the water. Further, if all minerals have been removed from the water it may, in some instances upon entering the body of the user attempt to draw nutrients and minerals from the user's body into the water. Thus, rather than being of assistance to the user it may actually serve to deplete some of the user's valuable salts, minerals and other necessary components. Accordingly, in one embodiment a controlled amount of selected minerals are provided to the water after it passes out of the electrolytic cell. The minerals added may include small amounts of calcium, iron and others. In addition, the water can be made more healthy by adding only exactly those minerals which are desired in the desired quantity such as small amounts of fluorine, small quantities of zinc, iron and other essential body nutrients. The appropriate vitamins can therefore be provided via the water with the appropriate final filter 45. The adding of minerals to highly purified water to make it more suitable for human consumption is known previously in the prior art, however it has not yet been used in a system having the combination of a reverse osmosis filter followed by an electrolytic cell of the present invention. Advantageously, according to the present invention the minerals and amount of mineral added can be exactly controlled so the users obtain the proper health benefits and flavor of the water.

The present invention also provides water having a low oxygen reduction potential. The oxygen reduction potential (ORP) is a measure of the number of free electrons in the water. Is normally measured in the millivolt and represents the affinity of the water for removing electrons from sources it comes in contact with. For example, normal tap water may have an ORP in the range of 300-600 millivolts or higher. With a high ORP, when it enters the body, electrons are withdrawn from the body to the water because there are a large number of free radicals in the water. The free radicals in the water serve as an oxidant and are considered to be detrimental to the health of an individual. The reverse osmosis filter 42 provides the advantages of significantly reducing the ORP of the water. Upon entering the reverse osmosis filter 42, water may have an ORP in the range of 600 millivolts. Upon exiting the reverse osmosis filter, it may be in the range of 100 or less since the reverse osmosis filter has removed a large number of minerals that produce free radicals from the water. The water is therefore more healthy in the respect that it does not have as many free radicals. When the water next passes through the electrolytic cell 36 after passing through the reverse osmosis filter, a large number of electrons are added to the water so that it obtains a negative ORP. For example, after exiting from the electrolytic cell 36, it may have an ORP of negative 100 millivolts to 200 millivolts. Thus, the water has no free radicals and instead, has additional electrolytes and may serve as an antioxidant to donate electrons if needed. The extra electrons in the water serve to absorb the free radicals that exist in the body so as to act as an antioxidant.

It has not previously been recognized that the combination of reverse osmosis filter followed by an electrolytic cell 36 provides the advantage of significantly reducing or removing altogether the free radicals and transitioning the water to have a negative ORP. The combination therefor, the reverse osmosis filter followed by the electrolytic cell 36 is in an advantageous treatment system which improves the overall health of the water over the use of a combination of other filtering systems which may incorporate the electrolytic cell 36. The combination may also have other benefits in improving the overall quality of the water besides the reduced ORP and addition of oxygen.

The electronic controls operate the power to the cell 18 in three modes. When the actuator switch 23 is first depressed, the electronic controls 34 enter a first mode of operation. During the first mode of operation, power is provided to the cell for a selected period of time regardless of whether the actuator switch 23 is released or pressed again. Once the actuator switch 23 is depressed, enabling the electronic controls, the current flows through the plates 76 for a minimum selected amount of time. In one embodiment, the selected amount of time for current flow is sixty seconds, though could be some other value, such as forty-five seconds, or the like. Once triggered, the current continues to run through the cell for the selected period of time even if the actuator switch 23 is released and the water valve is shut so water is not flowing out of tap 20. Thus, the water inside the electrolytic cell continues to be treated and is charged up with additional oxygen and electrons as has been described. For example, a user may normally depress the actuator switch 23 for thirty seconds to fill a glass of water, which may take fifteen to twenty seconds after which they will release the switch 23. The water flow stops, however, the electrolytic plates 67 continue to have power provided thereto for a full sixty seconds so as to pre-charge the water and fill chamber 73 with treated water for the next use. In one embodiment of the invention, the sixty second turn off delay is in addition to the time the tap is depressed, up to 2 minutes 45 seconds.

If the actuator switch 23 remains pressed beyond the selected period of time, the electronic circuit 34 enters the second mode of operation. During the second mode of operation, the on-time for power provided to the plates 76 tracks exactly the position of the actuator switch 23. The power on/off is linked to the actuator switch 23 to be controlled by the position of the switch. Namely, so long as the actuator switch 23 is depressed, power continues to be provided to the plates 76. When the actuator switch 23 is released, then power terminates to the plates 76 and the current terminates passing through the water. The second mode of operation is used if the switch is depressed for more than a selected period of time and released prior to the expiration of a third, extended time period.

If the switch 23 is depressed beyond the selected time period, the circuit enters a third mode of operation. The length of the extended time period is based on the capacity of the water tank 44. The extended time period approximately equals the amount of time to remove all water from a full tank 44. Thus, if three minutes is required to remove all the water from the tank 44, then the extended time period would be for three minutes. If the actuator switch 23 remains depressed continuously for three minutes with the valve open, then all water would have exited from the tank 44 based on its size and the circuits enters the third mode of operation. According to one embodiment in which the tank 44 is in the range of 1½-2 gallons, a maximum time period for the time to start the third mode is two minutes and forty-five seconds. Thus, at the expiration of two minutes and forty-five seconds the tank 44 will be expected to have been fully drained so that no more water is available for the use out of tap 20.

At the end of the extended time period, the electrical controls 34 enter a third mode of operation, that of automatic shut off. Once the extended time period has terminated, the electronic controls automatically shut off the current to the electrolytic cell. If the actuator switch 23 remains in the open position, a default circuit within the electronic controls 34 will automatically shut the current off to the cell to ensure that the plates do not burn up because no water is passing through the cells. Presumably, after a period of time the user will release actuator switch 23 so that it is no longer depressed, thus releasing the electrical circuit 34 from the third mode of operation in which the default is to automatically shut the current off.

In the event the actuator switch remains depressed for an excessive period of time, such as ten minutes, a fault light 71 will illuminate on the circuit board to alert the user that the actuator switch 23 appears to be stuck in the on position and corrective measures need to be taken. Once the actuator switch is closed, in any mode of operation, the system will reset itself automatically to start at the first mode and the electrolytic cell 36 will be available to perform another treatment sequence.

As will be appreciated, the length of time for each of the modes of operation, first mode, second mode and third mode, will be selected based on the design of each particular system. The first mode of operation is desired to be a length of time somewhat beyond that which the user would normally be expected in removing water from tap 20 to fill a glass or small pitcher. The length of time for the second mode of operation will be based on the time required to empty the tank 44 if it is completely full. According to one embodiment, there is a first mode and a third mode, but no second mode of operation in this embodiment. The electronic controls operate under the parameters of the first mode until the parameters of the third mode are met. The length of time for the third mode of operation, automatic shut off, will be based on the amount of time that is desired to give a user to make sure actuator switch 23 is not stuck and to release the valve so the tank 44 may once again begin to fill with water.

The water flow out of tank 44 is preferably at a relatively steady flow rate, under a known, constant pressure. The amount of current provided to the electric plates 76 is a preset current which is established by the electronic circuit 34 and does not change as water flows through the electrolytic cell 36. Since the water is flowing out of the tank 44 at a known, set rate, then the current can be set to a selected value to provide a known oxygenization of the water for the given flow rate at the direct current values as provided. Thus, it is not necessary to vary the amount of current provided to the plate 76 over one cycle, or from one cycle to the next, as is done in many other systems.

The electronic controls 34 contain the appropriate timers, power transistors and on/off switches to provide power to the system in a manner as described herein. For example, according to one embodiment, a timing circuit is provided on the printed circuit board 60 within the electronic controls 34 which operates as follows. The electronics on the circuit board 60 include standard timer circuits, switches and controls as would be available to those of skill in the art. For example, the timer circuit may be a simple 555 timer, available as an off-the-shelf electronic component. Power transistors may be provided which are switched via line 32 to carry a high current to the plates 76. Since the electronic controls are quite simple, a microprocessor need not be used but merely a 555 timer, together with some integrated memory having the software with three modes of operation stored therein and coupled to the appropriate timer and switch circuits. Thus, the electronic controls 34 can be relatively simple and low cost. Alternatively, if desired, a more complicated electronic controller can be used which may include a microprocessor to provide a more sophisticated software control system with the appropriate timer and switches enclosed within such microprocessor.

FIG. 6 illustrates one embodiment for a pressure control valve in association with the accumulator tank 44. As shown, the accumulator tank 44 includes water 47 at a selected level therein. Also within the accumulator tank 44 is a float 85 having an outlet valve 90. The float 85 is coupled to a rod 92 which pivots about a selected point and is coupled to the outer wall 88 of the accumulator tank 44. The outlet valve 90 is directly coupled to the outlet tube 95 leading out of the accumulator tank 44. The outlet tube 95 can be the same tube 50 as shown in prior embodiments, or may be any acceptable tube which carries water 47 out of the tank.

The operation of the outlet valve 90 is as follows. When water 47 is at a low level within the tank, the float 85 does not float in the water and the valve is shut. With the float 85 in the down position, the outlet valve 90 closes the outlet into the outlet tube 95 so that water may not exit from the accumulator tank 44. Even if the user presses switch 23 to request water, since the outlet valve 90 has closed, no water may exit from the system. The cell therefore, does not operate since no water is flowing in that embodiment in which the flow valve is present. Alternatively, if the electric controls are coupled to the switch 23, the cell may turn on for a short period of time, however, since no water is running, either no electricity will flow in the cell or the water which is present in the cell will be oxygenized but, it will not run out of the cell because there is no pressure behind the system.

As more and more water enters the accumulator tank 44, the water 47 will rise sufficiently high that the float 85 is floated upward, thus opening the outlet valve 90. Water may now run out of the pipe 95 and into the components downstream. When the level of the fluid in the tank drops so that the buoyancy of the flow no longer holds the valve open, the valve closes and prevents further flow of water from the tank. Simultaneously, the pressurized air above the water is prevented from escaping. The height, and position, of the float 85 is selected such that the valve will be closed at any time when the water 47 is still at least a small distance above the outlet pipe 95. Thus, air is always prevented from escaping outside the accumulator tank 44 and a sufficiently high air pressure is maintained within the tank accumulator 44 to force the water out upon demand by the user. Of course, as the water 47 rises and the outlet valve 90 opens, only water can escape, and no gas, because the gas is positioned above the water. As the water 47 begins to drop, the valve will close, thus preventing both water and gas from escaping and maintaining an acceptable pressure inside the tank.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A treatment system for processing water, comprising:
a first filter having an inlet and an outlet, the inlet of the first filter being configured to fluidly communicate with a source of the water;
an osmotic membrane contained within a first housing having an inlet and an outlet, the inlet of the first housing being in fluid communication with the outlet of the first filter;
a mineral supplement device coupled to the outlet of the housing containing the osmotic membrane;
an electrolytic cell contained within a second housing having an inlet and an outlet, the inlet of the second housing being in fluid communication with the outlet of the mineral supplement device;
a tap having an inlet, an outlet and an actuator, the inlet of the tap in fluid communication with the outlet of the second housing, the actuator of the tap being configured to open a valve to dispense water via the tap; and
an electronic control circuit coupled to activate the electrolytic cell.

2. The system of claim 1, further comprising a carbon filter having an inlet and an outlet, the inlet of the carbon filter being in fluid communication with the outlet of the first housing and positioned prior to the second housing.

3. The system of claim 2, further comprising a tank between the first housing and the carbon filter, the tap such that the water is stored in the system after a reverse osmotic process but prior to passing through the carbon filter.

4. The system of claim 1, further comprising a tank between the osmotic membrane and the tap such that the water is stored in the system after a reverse osmotic process, and wherein the control circuit is configured to stop a flow of water when the water level in the tank is below a selected level.

5. The system of claim 2, further comprising a check valve at the outlet of the tank to prevent water from exiting the tank when it is below a selected level.

6. The system of claim 1, further comprising:
a tank between the osmotic membrane and the tap such that the water is stored in the system after a reverse osmotic process; and
a check valve that is configured to stop a flow of water following a first duration after the tap is open, the first duration corresponding to the amount of time it takes for the water in the tank to be reduced from completely full to a selected level above empty, the control circuit further configured to stop the flow of water form the tank.

7. The system of claim 6, wherein the check valve is a pressure sensitive valve.

8. The system of claim 6, wherein the check valve is a float valve within the tank.

9. The system of claim 1, wherein each of the elements are sufficiently small to be collectively placed beneath a residential sink, and wherein the source of water is a residential utility line

10. The system of claim 3, wherein the second housing is elongated having a first end and a second end, the electrolytic cell being positioned horizontally on top of the tank.

11. The system of claim 1, including:
a filter prior to the osmotic filter; and
a pump prior to the osmotic filter that provides increased pressure in the water line.

12. A method for processing water, comprising:
drawing water from a source of water and passing the water drawn through a first filter for removing sediment and other pollutants;
passing the water through a reverse osmosis filter;
passing the water through a mineral supplement device after passing the water through the reverse osmosis filter, the mineral supplement device for adding minerals to the water that are beneficial to human health and also to increase the conductivity of the water;
passing the water recently treated through an electrolytic cell contained within a second housing having an inlet and an outlet, the inlet of the second housing being in fluid communication with the outlet of the first housing, in order to add oxygen to the water; and
dispensing the treated water when a user wishes to drink the water.

13. The method of claim 12, further including:
passing the water that has been treated in the reverse osmosis filter through a second filter prior to entering the mineral supplement device.

14. The method of claim 12, further including:
activating the electrolytic cell each time that water is being dispensed.

15. The method of claim 12, further comprising:
storing the water in a tank after it exits the reverse osmosis filter and prior to entering the electrolytic cell.
